(19) United States
(12) Patent Application Publication
(10) Pub. No.: US 2013/0238361 A1
(43) Pub. Date: Sep. 12, 2013

(54) MEDICAL INFORMATION MANAGING SYSTEM, MEDICAL INFORMATION MANAGING APPARATUS, AND MEDICAL INFORMATION DISPLAYING APPARATUS

(71) Applicants: KABUSHIKI KAISHA TOSHIBA, Minato-Ku (JP); TOSHIBA MEDICAL SYSTEMS CORPORATION, Otawara-Shi (JP)

(72) Inventors: Koichi TERAI, Otawara-Shi (JP); Kenichi Niwa, Otawara-Shi (JP); Naoto Takaku, Nasushiobara-Shi (JP); Yosuke Hirasawa, Nasushiobara-Shi (JP)

(73) Assignees: Toshiba Medical Systems Corporation, Otawara-Shi (JP); Kabushiki Kaisha Toshiba, Minato-Ku (JP)

(21) Appl. No.: 13/868,684

(22) Filed: Apr. 23, 2013

Related U.S. Application Data
(63) Continuation of application No. PCT/JP2012/051228, filed on Jan. 20, 2012.

(30) Foreign Application Priority Data
Jan. 20, 2011 (JP) 2011-009816

(51) Int. Cl. G06F 19/00

(52) U.S. Cl. CPC G06F 19/322
USPC 705/3

(57) ABSTRACT

A medical information managing system includes a display instructing unit and an identity determining unit. The display instructing unit generates data of a screen that shows medical data concerning patient information and instructs a display device to display the screen if the medical data concerning the patient information is acquired from a storing device and if a medical application for displaying the acquired medical data is executed. The identity determining unit determines, if a plurality of the medical applications are executed, an identity of a plurality of pieces of patient information corresponding to the respective medical applications.

### CROSS-REFERENCE TO RELATED APPLICATION

This application is a Continuation Application of No. PCT/JP2012/051228, filed on Jan. 20, 2012, and the PCT application is based upon and claims the benefit of priority from Japanese Patent Application No. 2011-9816, filed on Jan. 20, 2011, the entire contents of which are incorporated herein by reference.

### FIELD

An embodiment as an aspect of the present invention relates to a medical information managing system, a medical information managing apparatus, and a medical information displaying apparatus that executes a medical application for displaying medical data to thereby display the medical data.

### BACKGROUND

A medical information managing system includes a medical image generating apparatus such as an X-ray computed tomographic (CT) apparatus and a magnetic resonance imaging (MRI) apparatus, various servers, and a client terminal. Examples of the various servers include a medical image storing apparatus, a medical report (radiogram interpretation report) storing apparatus, and an electronic medical chart storing apparatus. The medical image generating apparatus, the various servers, and the client terminal are communicably connected to one another through a network.

The medical image storing apparatus stores a medical image of a patient acquired by the medical image generating apparatus. A healthcare professional (hereinafter, referred to as “operator”) refers to a medical image displayed on the client terminal, writes medical findings about the medical image into a medical report creating screen displayed on the client terminal, and creates a medical report. The created medical report is recorded in the medical report storing apparatus.

Medical data from each server is displayed on the client terminal by a medical application provided by each server. Accordingly, screens of a large number of medical applications are displayed on the client terminal. The medical applications displayed on the client terminal are roughly classified into an image displaying application provided by the medical image storing apparatus, a report creating application provided by the medical report storing apparatus, and an electronic medical chart displaying application provided by the electronic medical chart storing apparatus. The image displaying application is further divided into a 2D image displaying application and a 3D image displaying application. Further, in the case where medical applications in the same classification are provided by a plurality of makers, for example, a first medical image storing apparatus that provides a first image displaying application and a second medical image storing apparatus that provides a second image displaying application may exist in some cases, so that the client terminal executes many kinds of applications.

When the operator creates a medical report, the client terminal uses the image displaying application that is a medical application provided by the medical image storing apparatus, in order to display a medical image necessary to create the medical report. When the operator creates the medical report, the client terminal also displays various pieces of medical data necessary to create the medical report, in addition to the medical image. For example, the client terminal collects and displays the medical data with the use of the report creating application that is a medical application provided by the medical report storing apparatus, and the electronic medical chart displaying application that is a medical application provided by the electronic medical chart storing apparatus.

Some medical applications link with one another using a patient identification (ID). For example, if the client terminal displays a medical report of a first patient using the report creating application, the image displaying application automatically links with the report creating application, and displays a medical image of the first patient. Such an automatic linkage of the medical applications provides consistency of a patient displayed by each medical application.

In a normal state of the client terminal that uses a plurality of medical applications that link with one another using a patient ID, basically, all the medical applications always display medical data of the same patient. In the client terminal, all the medical applications always display the medical data of the same patient at the beginning, but the linkage of the plurality of medical applications does not function normally due to factors such as a lock of a medical application, a shutdown of a network, and a down of each managing apparatus, and the client terminal may come into a dangerous state (in which the plurality of medical applications display different patients). For example, the client terminal unfavorably displays a medical report of a first patient using the report creating application while displaying a medical image of a second patient using the image displaying application.

In the case where the plurality of medical applications display different patients, the client terminal displays pieces of medical data of the different patients on the same screen. Hence, the operator has trouble in selecting only medical data of a desired patient, for example, medical data of a second patient from the large number of pieces of medical data displayed on the client terminal, resulting in a decrease in creation efficiency of a medical report.

In addition, in the case where the plurality of medical applications display different patients, the operator may even write findings about a medical image of a second patient into a medical report creating screen of a first patient, in case of his/her lack of attention. As a result, an operator who refers to the created medical report may make a wrong diagnosis.

The present invention has an object to improve efficiency of operator's work in a medical information managing system including a client terminal by informing the operator of a dangerous state, a warning state and their countermeasures, even in the case where different patient IDs are displayed on a plurality of screens corresponding to a plurality of medical applications that are required to have an identity of a patient therebetween.

### BRIEF DESCRIPTION OF THE DRAWINGS

In accompanying drawings,

FIG. 1 is a schematic diagram illustrating a configuration of a medical information managing system according to the present embodiment;

FIG. 2 is a schematic diagram illustrating configurations of servers and a client terminal included in the medical information managing system according to the present embodiment;

FIG. 3 is a diagram illustrating attribute data stored in an attribute storing device of the client terminal;

FIG. 4 is a schematic diagram illustrating a modified example of configurations of the servers and the client terminal included in the medical information managing system according to the present embodiment;

FIG. 5 is a diagram illustrating attribute data stored in an attribute storing device of a medical image storing apparatus;

FIG. 6 is a diagram illustrating attribute data stored in an attribute storing device of a medical report storing apparatus;

FIG. 7 is a block diagram illustrating a first function of the medical information managing system according to the present embodiment;

FIG. 8 is a diagram illustrating an example of a medical image displaying screen and a medical report creating screen that are displayed on a displaying device and concern a required patient ID;

FIG. 9 is a diagram to explain procedures of identifying a patient;

FIG. 10 is a conceptual diagram to explain a method of comparing a plurality of pieces of patient information displayed by a plurality of medical applications;

FIG. 11 is a diagram illustrating an example of a normal state and a dangerous state displayed on the displaying device;

FIG. 12 is a diagram illustrating a first example of the dangerous state displayed on the displaying device;

FIG. 13 is a diagram illustrating a second example of the dangerous state displayed on the displaying device;

FIG. 14 is a block diagram illustrating a second function of the medical information managing system according to the present embodiment;

FIG. 15 is a diagram illustrating a first example of a warning state displayed on the displaying device; and

FIG. 16 is a diagram illustrating a second example of the warning state displayed on the displaying device.

### DETAILED DESCRIPTION

A medical information managing system, a medical information managing apparatus, and a medical information displaying apparatus according to the present embodiment is described with reference to the attached drawings.

To solve the above-described problems, the present embodiments provide the medical information managing system includes: a display instructing unit configured to generate data of a screen that shows medical data concerning patient information and to instruct a display device to display the screen if the medical data concerning the patient information is acquired from a storing device and if a medical application for displaying the acquired medical data is executed; and an identity determining unit configured to determine, if a plurality of the medical applications are executed, an identity of a plurality of pieces of patient information corresponding to the respective medical applications.

To solve the above-described problems, the present embodiments provide the medical information managing apparatus includes: a display instructing unit configured to generate data of a screen that shows medical data concerning patient information and to instruct an outside medical information displaying apparatus to display the screen if the medical data concerning the patient information is acquired from a storing device and if a medical application for displaying the acquired medical data is executed; and an identity determining unit configured to determine, if a plurality of the medical applications are executed, an identity of a plurality of pieces of patient information corresponding to the respective medical applications.

To solve the above-described problems, the present embodiments provide the medical information displaying apparatus includes: a display instructing unit configured to generate data of a screen that shows medical data concerning patient information and to instruct a display device to display the screen if the medical data concerning the patient information is acquired from a storing device and if a medical application for displaying the acquired medical data is executed; and an identity determining unit configured to determine, if a plurality of the medical applications are executed, an identity of a plurality of pieces of patient information corresponding to the respective medical applications.

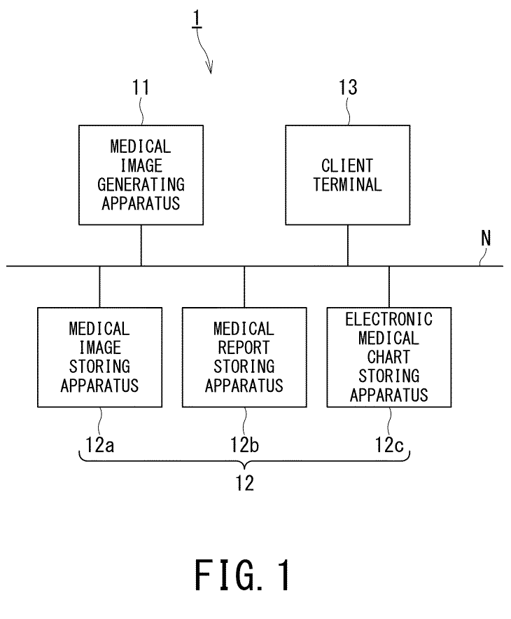

FIG. 1 is a schematic diagram illustrating a configuration of a medical information managing system according to the present embodiment.

FIG. 1 illustrates a medical information managing system 1 according to the present embodiment. The medical information managing system 1 includes a medical image generating apparatus (modality) 11, a server 12, and a client terminal 13. Examples of the server 12 include a medical image storing apparatus 12a, a medical report storing apparatus 12b, and an electronic medical chart storing apparatus 12c. The medical image generating apparatus (modality) 11, the server 12, and the client terminal 13 can communicate with one another through a network N such as a local area network (LAN). Note that the medical information managing system 1 may include a plurality of the medical image generating apparatuses (modalities) 11, the servers 12, and/or the client terminals 13.

The medical image generating apparatus 11 photographs an examination region of a patient as an object, and generates a medical image of the examination region as medical data. The generated medical image is transmitted as DICOM data to the medical image storing apparatus 12a.

The medical image storing apparatus 12a as the server 12 stores the medical image transmitted from the medical image generating apparatus 11, and manages the medical image in the form of a database.

The medical report storing apparatus 12b as the server 12 stores a medical report as medical data into which findings and the like about the medical image are written, and manages the medical report in the form of a database.

The electronic medical chart storing apparatus 12c as the server 12 stores an electronic medical chart as medical data into which a disease name, contents of a medical interview, and the like are written, and manages the electronic medical chart in the form of a database.

In order to enable an operator to create a medical report, the client terminal 13 receives and displays the medical data such as the medical image, the medical report, and the electronic medical chart stored in the respective servers 12, in accordance with an instruction of the operator.

The medical data from each server 12 is displayed on the client terminal 13 by executing a medical application provided by each server 12. Accordingly, screens of a large number of medical applications are displayed on the client terminal 13 using the large number of medical applications. The medical applications provided by the servers 12 are roughly classified into: an image displaying application provided by the medical image storing apparatus 12a; a report creating application provided by the medical report storing apparatus 12b; and an electronic medical chart displaying application provided by the electronic medical chart storing apparatus 12c. The image displaying application is further divided into a 2D image displaying application and a 3D image displaying application. Further, in the case where medical applications in the same classification are provided by a plurality of makers, for example, a first medical image storing apparatus that provides a first image displaying application and a second medical image storing apparatus that provides a second image displaying application may exist as the medical image storing apparatus 12a in the same classification in some cases, so that the client terminal 13 displays screens of various kinds of medical applications.

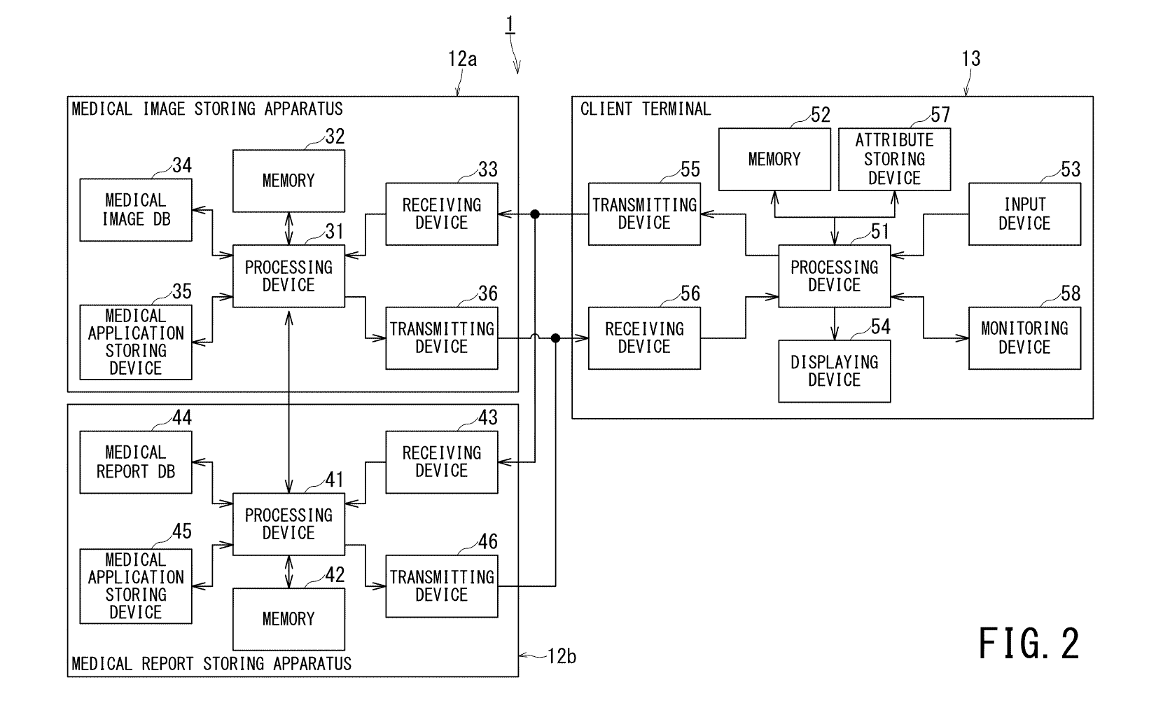

FIG. 2 is a schematic diagram illustrating configurations of the servers 12 and the client terminal 13 included in the medical information managing system 1 according to the present embodiment. Note that, in FIG. 2, the medical image storing apparatus 12a and the medical report storing apparatus 12b of the servers 12 are described as an example.

The medical image storing apparatus 12a includes a processing device (CPU) 31, a memory 32, a receiving device 33, a medical image database (DB) 34, a medical application storing device 35, and a transmitting device 36.

The processing device 31 is a control unit having a large-scale integration (LSI) circuit configuration in which an electronic circuit formed of a semiconductor is sealed in a package having a plurality of terminals. The processing device 31 executes programs stored in the memory 32 and the medical application storing device 35. The processing device 31 executes a medical application stored in the medical application storing device 35, to thereby provide a screen and logic of the executed medical application and a medical image stored in the medical image DB 34 to the client terminal 13 through the transmitting device 36. In addition, the processing device 31 functions as a system (DBMS) that manages the medical image DB 34, and implements processes such as sharing, protection, search, and update of a medical image as the medical data.

The memory 32 is a memory device including a read only memory (ROM) and a random access memory (RAM). The memory 32 is used as a working memory of the processing device 31 and is also used to temporarily store data.

The receiving device 33 receives medical data transmitted from the client terminal 13.

The medical image DB 34 stores a medical image as the medical data.

The medical application storing device 35 stores the image displaying application as a medical application for providing a medical image to the client terminal 13.

The transmitting device 36 transmits medical data to the client terminal 13.

The medical report storing apparatus 12b includes a processing device (CPU) 41, a memory 42, a receiving device 43, a medical report DB 44, a medical application storing device 45, and a transmitting device 46.

The processing device 41 is a control unit having the large-scale integration circuit configuration in which an electronic circuit formed of a semiconductor is sealed in a package having a plurality of terminals, similarly to the processing device 31. The processing device 41 executes programs stored in the memory 42 and the medical application storing device 45. The processing device 41 executes a medical application stored in the medical application storing device 45, to thereby provide a screen and logic of the executed medical application and a medical report stored in the medical report DB 44 to the client terminal 13 through the transmitting device 46. In addition, the processing device 41 functions as a system that manages the medical report DB 44, and implements processes such as sharing, protection, search, and update of a medical report as the medical data.

The memory 42 is a memory device including a ROM and a RAM, similarly to the memory 32. The memory 42 is used as a working memory of the processing device 41 and is also used to temporarily store data.

The receiving device 43 receives medical data transmitted from the client terminal 13, similarly to the receiving device 33.

The medical report DB 44 stores a medical report as the medical data.

The medical application storing device 45 stores the report creating application as a medical application for providing a report application to the client terminal 13.

The transmitting device 46 transmits data to the client terminal 13, similarly to the transmitting device 36.

The medical image storing apparatus 12a and the medical report storing apparatus 12b link with each other using a patient ID through the processing devices 31 and 41.

The client terminal 13 includes a processing device (CPU) 51, a memory 52, an input device 53, a displaying device 54, a transmitting device 55, a receiving device 56, an attribute storing device 57, and a monitoring device 58.

The processing device 51 is a control unit having the large-scale integration circuit configuration in which an electronic circuit formed of a semiconductor is sealed in a package having a plurality of terminals. If the operator operates the input device 53 to thereby input a command, the processing device 51 executes a program stored in the memory 52. The processing device 51 provides a graphical user interface (GUI) that uses many graphics for displaying information for the operator on the displaying device 54 and enables the operator to perform a basic operation using the input device 53.

The memory 52 is a memory device including a ROM and a RAM. The memory 52 is used as a working memory of the processing device 51 and is also used to temporarily store data.

The input device 53 is a pointing device that can be operated by the operator, and an input signal according to the operation is transmitted to the processing device 51.

The displaying device 54 includes an image synthesizing circuit, a video random access memory (VRAM), and a display, which are not illustrated. The displaying device 54 displays a screen of each medical application provided through the receiving device 56.

The transmitting device 55 transmits a display request (request) of medical data created by the processing device 51 to the receiving device 33 of the medical image storing apparatus 12a and the receiving device 43 of the medical report storing apparatus 12b. The transmitting device 55 also transmits the medical data created by the processing device 51 to the receiving device 33 of the medical image storing apparatus 12a and the receiving device 43 of the medical report storing apparatus 12b.

The receiving device 56 receives a screen and logic of an executed medical application and medical data requested to be displayed, from the transmitting device 36 of the medical image storing apparatus 12a or the transmitting device 46 of the medical report storing apparatus 12b.

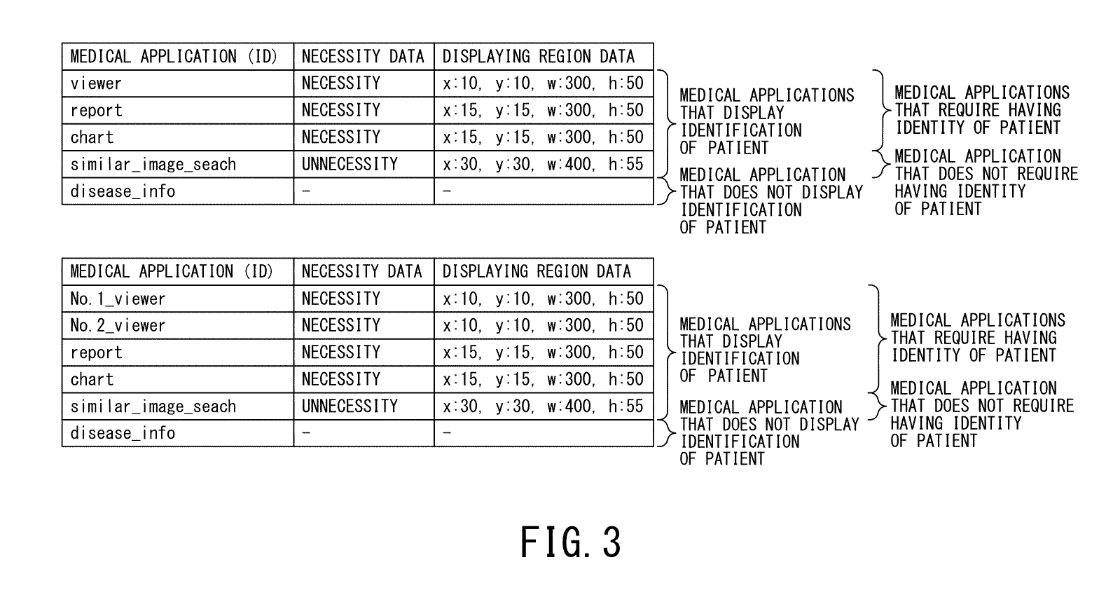

The attribute storing device 57 stores attribute data concerning a medical application for displaying, on the screen, discrimination information of a patient such as a patient identification (ID), among medical applications executed by the server 12. The attribute data of the medical application is set in advance by an operator or a service staff. The attribute data of the medical application contains at least necessity data of identity determination of a displayed patient and displaying region data as described with reference to FIG. 3.

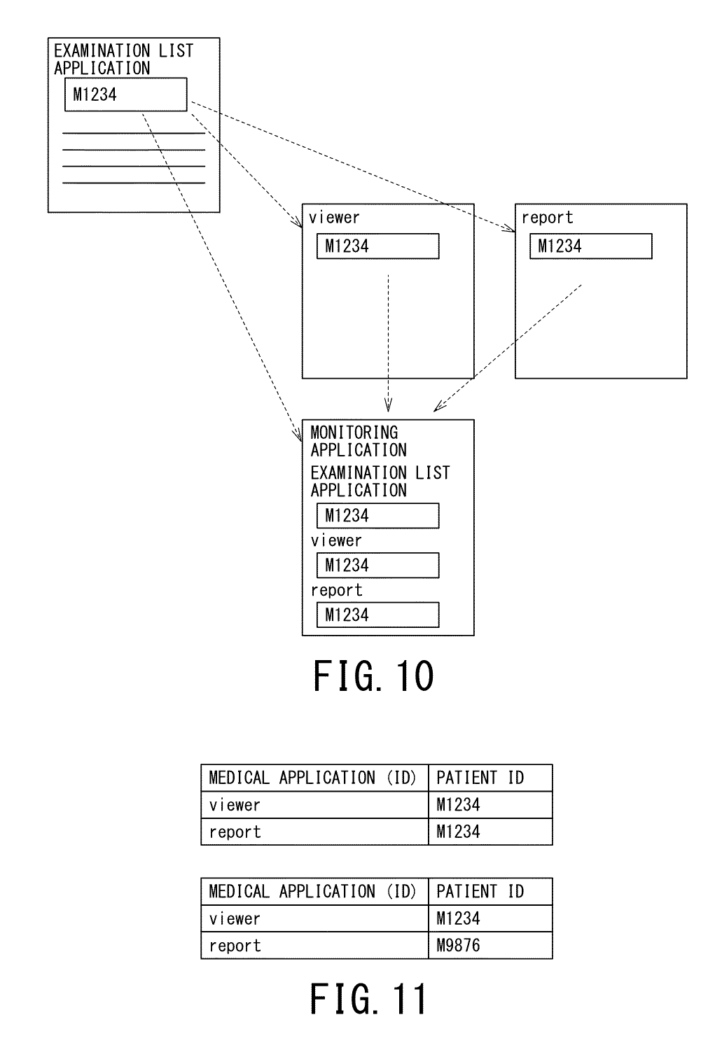

As illustrated in FIG. 10 to be described later, the monitoring device 58 compares a patient ID (M1234) transmitted from an examination list application with a patient ID transmitted from the image displaying application, and also compares the patient ID (M1234) transmitted from the examination list application with a patient ID transmitted from the report creating application, to thereby determine whether or not the image displaying application and the report creating application each display the patient ID (M1234) requested to be displayed. That is, the monitoring device 58 determines whether or not a mismatch between the patient IDs occurs. The monitoring device 58 may actively acquire the patient IDs from the examination list application, the image displaying application, and the report creating application, instead of passively acquiring the patient IDs from the respective applications.

FIG. 3 is a diagram illustrating the attribute data stored in the attribute storing device 57 of the client terminal 13.

As illustrated in FIG. 3, the attribute data of the medical application contains the necessity data indicating whether or not this medical application requires having an identity of a displayed patient between this medical application and another medical application.

Some medical applications provide to the client terminal 13 display a patient ID, and other medical applications provided thereto do not display a patient ID. Examples of the former medical applications include: the image displaying application (ID: viewer) executed by the medical image storing apparatus 12a; the report creating application (ID: report) and a similar disease case searching application (ID: similar image seach) executed by the medical report storing apparatus 12b; and the electronic medical chart displaying application (ID: chart) executed by the electronic medical chart storing apparatus 12c (illustrated in FIG. 1). Here, in the case as illustrated in a lower part of FIG. 3 where the medical information managing system 1 includes a plurality of the servers 12 in the same classification, for example, a plurality of the medical image storing apparatuses 12a, the attribute data of the medical application contains the necessity data for each image displaying application (ID: No.1_viewer, No.2_viewer) of the plurality of medical image storing apparatuses 12a.

Meanwhile, examples of the latter medical applications include: a disease case information displaying application (ID: disease_info) for displaying disease case information; and an administrative information displaying application for displaying administrative information in a hospital. In the first place, the latter medical applications do not need to be required to have the identity of the displayed patient between these latter medical applications and another medical application.

Further, some former medical applications are required to have the identity of the displayed patient between these former medical applications and another medical application, and other former medical applications are not required to have the same. For example, the similar disease case searching application executed by the medical report storing apparatus 12b is a medical application for searching for and displaying medical images with findings that are similar to image findings about a patient whose radiogram is currently interpreted, and patients of the medical images as search results do not require being identical with each other.

As illustrated in FIG. 3, the attribute data of the medical application further contains the displaying region data of a patient ID on a screen of an executed medical application. The displaying region data is designated on the screen of the executed medical application using an x-coordinate (x), a y-coordinate (y), a width (w), and a height (h). Note that the displaying region data does not necessarily need to be fixed values, and may be a formula for calculating the displaying region. As illustrated in FIG. 3, the image displaying application (ID: viewer) as the medical application is set so as to display the patient ID using displaying region data “x: 10, y: 10, w: 300, h: 50” on the screen.

Note that, in FIG. 2, the client terminal 13 includes the attribute storing device 57 that collectively stores pieces of attribute data of the medical application, but the present embodiment is not limited thereto. For example, another apparatus connected to the network N may include the attribute storing device 57. Alternatively, for example, each server 12 may include the attribute storing device 57 together with the medical application.

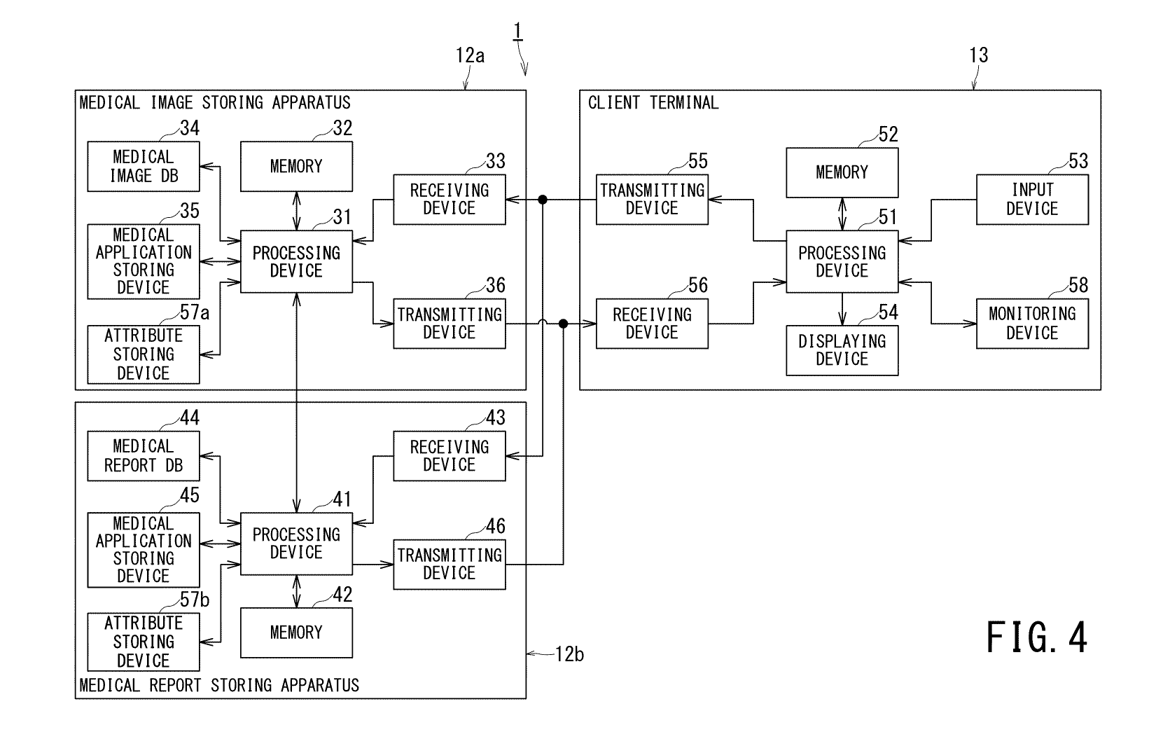

FIG. 4 is a schematic diagram illustrating a modified example of configurations of the servers 12 and the client terminal 13 included in the medical information managing system 1 according to the present embodiment.

The medical image storing apparatus 12a includes the processing device 31, the memory 32, the receiving device 33, the medical image DB 34, the medical application storing device 35, the transmitting device 36, and an attribute storing device 57a. Note that, in FIG. 4, the same components as those in FIG. 2 are denoted by the same reference signs, and description thereof is omitted.

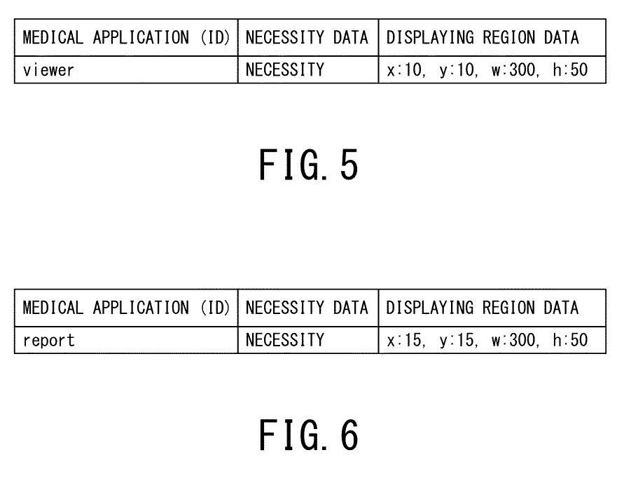

The attribute storing device 57a stores only attribute data concerning the medical application stored in the medical application storing device 35, among the pieces of attribute data stored in the attribute storing device 57 illustrated in FIG. 2. The medical application storing device 35 of the medical image storing apparatus 12a illustrated in FIG. 4 stores the image displaying application as the medical application, and hence the attribute storing device 57a stores only the attribute data concerning the image displaying application. The attribute data stored in the attribute storing device 57a is illustrated in FIG. 5.

The medical report storing apparatus 12b includes the processing device 41, the memory 42, the receiving device 43, the medical report DB 44, the medical application storing device 45, the transmitting device 46, and an attribute storing device 57b.

The attribute storing device 57b stores only attribute data concerning the medical application stored in the medical application storing device 45, among the pieces of attribute data stored in the attribute storing device 57 illustrated in FIG. 2. The medical application storing device 45 of the medical report storing apparatus 12b illustrated in FIG. 4 stores the report creating application as the medical application, and hence the attribute storing device 57b stores only the attribute data concerning the report creating application. The attribute data stored in the attribute storing device 57b is illustrated in FIG. 6.

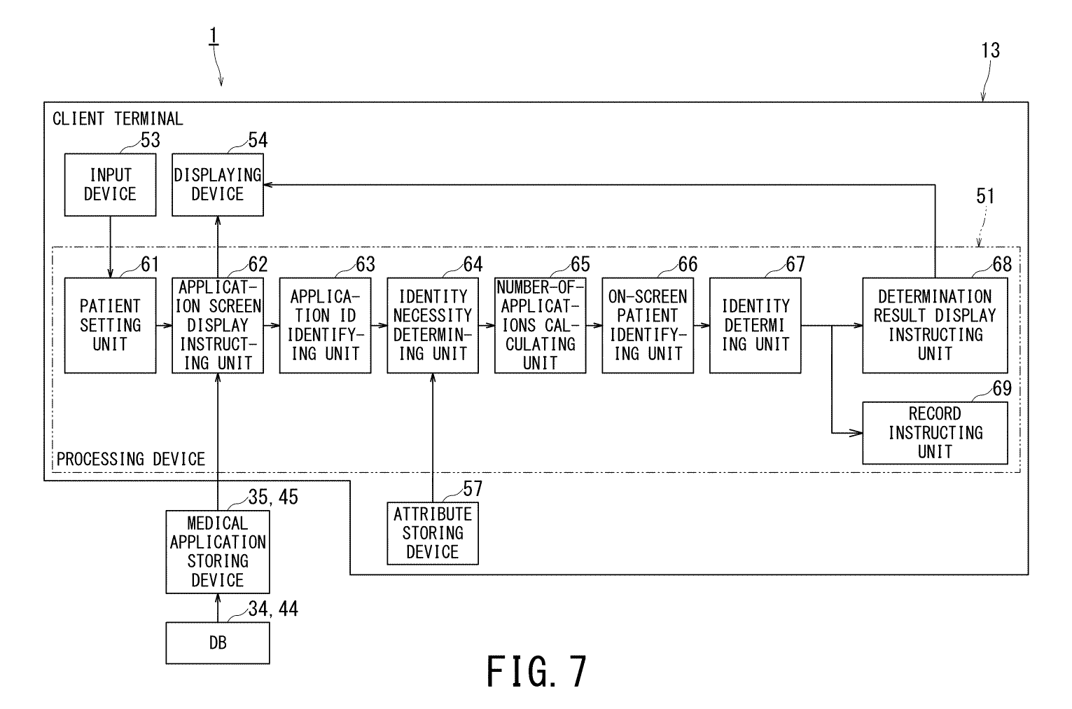

FIG. 7 is a block diagram illustrating a first function of the medical information managing system 1 according to the present embodiment.

When the processing device 51 illustrated in FIG. 2 executes a program, as illustrated in FIG. 7, the client terminal 13 functions as a patient setting unit 61, an application screen display instructing unit 62, an application ID identifying unit 63, an identity necessity determining unit 64, a number-of-applications calculating unit 65, an on-screen patient identifying unit 66, an identity determining unit 67, a determination result display instructing unit 68, and a record instructing unit 69. Note that the entirety or a part of the components 61 to 69 of the client terminal 13 may be included in the client terminal 13 in the form of hardware. In addition, the entirety or a part of the components 61 to 69 may be included in any of the servers 12.

The patient setting unit 61 has a function of setting a patient (patient ID) for which a medical report should be created, on the basis of an input signal that is inputted by the operator through the input device 53 with the use of an examination list screen (examination list application) and the like.

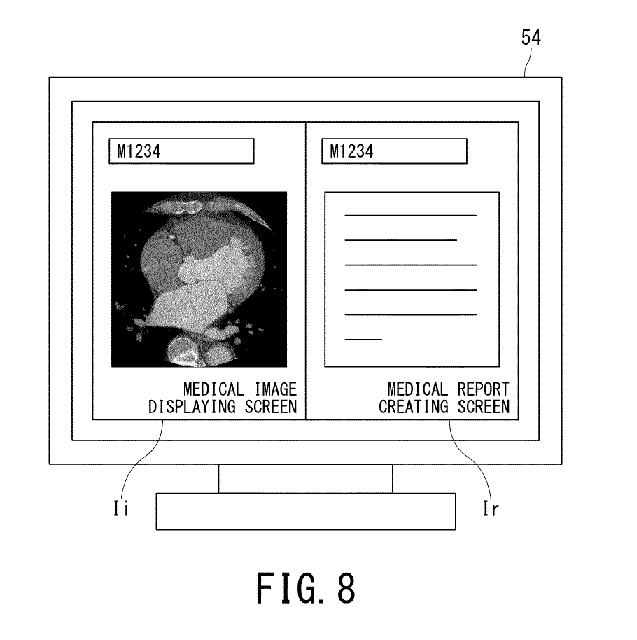

The application screen display instructing unit 62 has: a function of transmitting, to the server 12, a display request of medical data corresponding to the patient ID set by the patient setting unit 61; and a function of receiving: a screen and logic of a medical application executed for displaying medical data requested to be displayed; and the medical data requested to be displayed, to thereby instruct the displaying device 54 to display the screen of the executed application. For example, the application screen display instructing unit 62 receives: a screen and logic of the image displaying application executed for displaying a medical image corresponding to the patient ID set by the patient setting unit 61; and the medical image requested to be displayed, from the medical image storing apparatus 12a, to thereby instruct the displaying device 54 to display the screen of the executed image displaying application. The application screen display instructing unit 62 also receives: a screen and logic of the report creating application executed for displaying a medical report corresponding to the patient ID set by the patient setting unit 61; and the medical report requested to be displayed, from the medical report storing apparatus 12b, to thereby instruct the displaying device 54 to display the screen of the executed report creating application. An example of a medical image displaying screen Ii and a medical report creating screen Ir that are displayed on the displaying device 54 and concern a required patient ID (ID: M1234) is illustrated in FIG. 8.

The application ID identifying unit 63 has a function of identifying an ID of a medical application that is received from the server 12 by the application screen display instructing unit 62, at timing at which a screen is displayed by a display instruction from the application screen display instructing unit 62 or in a predetermined cycle. The medical application ID is identified using information of a process and information of association with the medical application ID. The information of association is given in advance by an operator or a service staff.

A typical process of identifying a medical application ID by the application ID identifying unit 63 is performed in the following manner. The application ID identifying unit 63 acquires a list of processes of the medical application received by the application screen display instructing unit 62. Each process includes information such as a name managed by an operating system (OS) and a path name of an executable file. The application ID identifying unit 63 acquires information of each process from the OS, and identifies the medical application ID on the basis of information of association between the acquired information and the medical application ID. Note that a medical application that is not associated with the medical application ID is excluded from targets of the identity determination of the displayed patient.

The identity necessity determining unit 64 has a function of determining whether or not the medical application having the medical application ID identified by the application ID identifying unit 63 must have the identity of the displayed patient between this medical application and another medical application, on the basis of the attribute data that corresponds to the medical application ID identified by the application ID identifying unit 63 and is stored in the attribute storing device 57. For example, the identity necessity determining unit 64 refers to the attribute data of the image displaying application stored in the attribute storing device 57, and determines whether or not the image displaying application must have the identity of the displayed patient between this image displaying application and the report creating application. Similarly, the identity necessity determining unit 64 refers to the attribute data of the report creating application stored in the attribute storing device 57, and determines whether or not the report creating application must have the identity of the displayed patient between this report creating application and the image displaying application.

The number-of-applications calculating unit 65 has a function of calculating the number of medical applications that are determined by the identity necessity determining unit 64 as being required to have the identity of the displayed patient. In the case where the number of medical applications that are determined by the identity necessity determining unit 64 as being required to have the identity of the displayed patient is 0 or 1, the number-of-applications calculating unit 65 stands by for setting of a patient ID by the patient setting unit 61.

The on-screen patient identifying unit 66 has a function of identifying, if the number of medical applications calculated by the number-of-applications calculating unit 65 that are determined as being required to have the identity of the displayed patient is more than one, a plurality of pieces of patient information, for example, patient IDs, that are actually displayed on a plurality of screens corresponding to the respective medical applications that are determined as being required to have the identity of the displayed patient.

In principle, the medical application that displays a patient ID always displays the patient ID that identifies the patient within the screen of the medical application, in order to prevent the operator from making a wrong diagnosis.

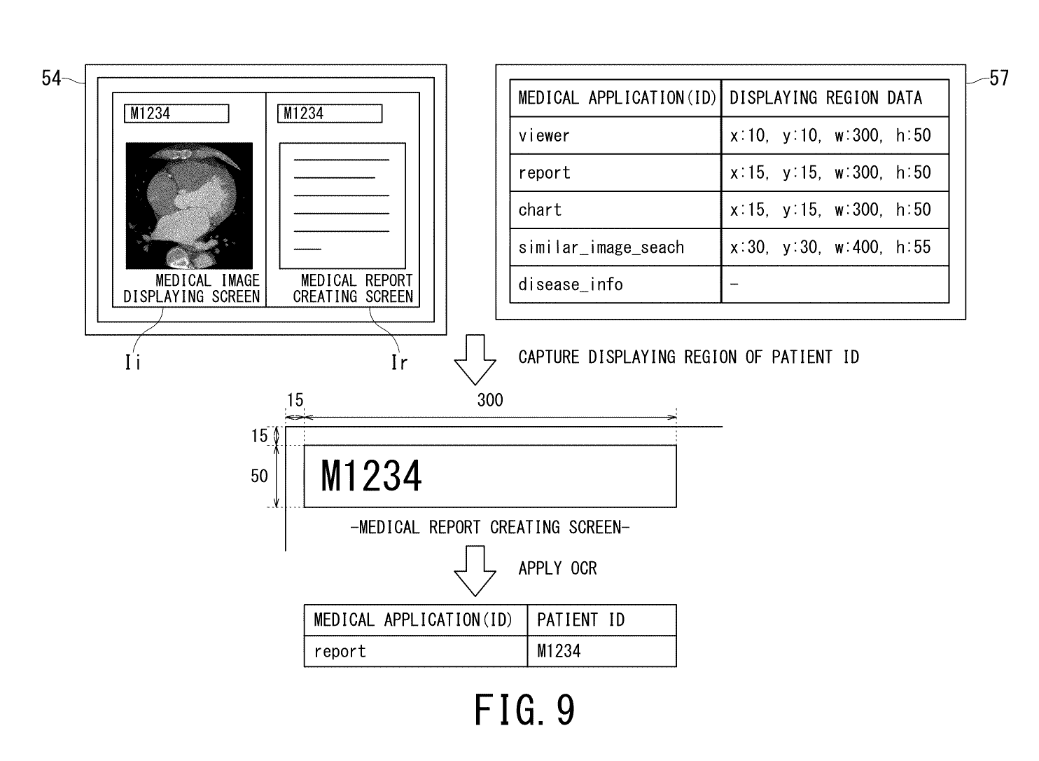

FIG. 9 is a diagram to explain procedures of identifying a patient.

As illustrated in an upper part of FIG. 9, the displaying device 54 displays a plurality of screens that concern a required patient ID (ID: M1234) and correspond to respective medical applications that are required to have the identity of the displayed patient, for example, the medical image displaying screen Ii and the medical report creating screen Ir. The attribute storing device 57 stores displaying region data of the patient ID on the medical image displaying screen Ii and displaying region data of the patient ID on the medical report creating screen Ir.

As illustrated in a middle part of FIG. 9, the displaying region of the patient ID on the medical report creating screen Ir is captured on the basis of the medical report creating screen Ir illustrated in the upper part of FIG. 9 and the displaying region data of the report creating application. Then, an optical character reader (OCR) is applied to the captured image, and a character string included in the captured image is extracted as illustrated in a lower part of FIG. 9. The extracted character string is identified as the patient ID of the patient being displayed on the medical report creating screen Ir. Also for the medical image displaying screen Ii, the extracted character string is identified as the patient ID of the patient being displayed on the medical image displaying screen Ii, similarly to the medical report creating screen Ir.

The identity determining unit 67 illustrated in FIG. 7 has a function of determining the identity of a plurality of pieces of patient information corresponding to respective screens that are actually displayed in accordance with a plurality of display instructions obtained by executing a plurality of medical applications. The identity determining unit 67 compares the plurality of pieces of patient information, for example, patient IDs, that are identified by the on-screen patient identifying unit 66 and correspond to the respective screens, to thereby determine whether or not a mismatch between the patient IDs occurs. The identity determining unit 67 determines whether the client terminal 13 is in a normal state in which a plurality of screens of the same patient ID are displayed on the displaying device 54, or a dangerous state in which a plurality of screens of different patient IDs are displayed on the displaying device 54 in spite of the fact that the identity of the displayed patient is required. In the case of the normal state, the identity determining unit 67 stands by for setting of a patient ID by the patient setting unit 61.

Note that description is given above of the case where the on-screen patient identifying unit 66 identifies the plurality of patient IDs actually displayed on the plurality of screens, on the basis of the displaying region data contained in the attribute data stored in the attribute storing device 57 and where the identity determining unit 67 compares the plurality of patient IDs actually displayed on the plurality of screens, but the present embodiment is not limited thereto. Another example is described with reference to FIG. 10.

FIG. 10 is a conceptual diagram to explain a method of comparing a plurality of pieces of patient information displayed by a plurality of medical applications.

As illustrated in FIG. 10, the image displaying application (ID: viewer) and the report creating application (ID: report) are executed in response to a display request of the patient ID (M1234) that is set on the examination list screen (examination list application) by the patient setting unit 61, and the screen illustrated in FIG. 8 is displayed on the displaying device 54. In addition, the examination list application transmits, to the monitoring device 58, a message to the effect that the display request of the patient ID (M1234) has been made.

Meanwhile, the image displaying application and the report creating application each transmit the patient ID actually displayed on the screen to the monitoring device 58. At this time, by means of a monitoring application, the monitoring device 58 compares the patient ID (M1234) of the display request transmitted from the examination list application with the actually displayed patient ID transmitted from the image displaying application, and also compares the patient ID (M1234) of the display request transmitted from the examination list application with the actually displayed patient ID transmitted from the report creating application. In this way, the monitoring device 58 determines whether or not the image displaying application and the report creating application each display the patient ID (M1234) requested to be displayed. That is, the monitoring device 58 determines whether or not a mismatch between the patient IDs occurs.

Alternatively, the image displaying application and the report creating application each transmit the patient ID actually displayed on the screen to the monitoring device 58. At this time, by means of the monitoring application, the monitoring device 58 compares the actually displayed patient ID transmitted from the image displaying application with the actually displayed patient ID transmitted from the report creating application. In this way, the monitoring device 58 determines whether or not the image displaying application and the report creating application each display the patient ID (M1234) requested to be displayed.

FIG. 11 is a diagram illustrating an example of the normal state and the dangerous state displayed on the displaying device 54.

An upper part of FIG. 11 illustrates a combination example of the patient IDs that is determined as the normal state by the identity determining unit 67. In the upper part of FIG. 11, the patient ID displayed by the image displaying application (ID: viewer) is identical with the patient ID displayed by the report creating application (ID: report).

A lower part of FIG. 11 illustrates a combination example of the patient IDs that is determined as the dangerous state by the identity determining unit 67. In the lower part of FIG. 11, the patient ID displayed by the image displaying application (ID: viewer) is different from the patient ID displayed by the report creating application (ID: report).

The determination result display instructing unit 68 illustrated in FIG. 7 has a function of instructing, if the determination result by the identity determining unit 67 shows that the client terminal 13 is in the dangerous state, the displaying device 54 to display this fact. If the dangerous state is displayed on the displaying device 54, the determination result display instructing unit 68 stands by for setting of a patient ID by the patient setting unit 61.

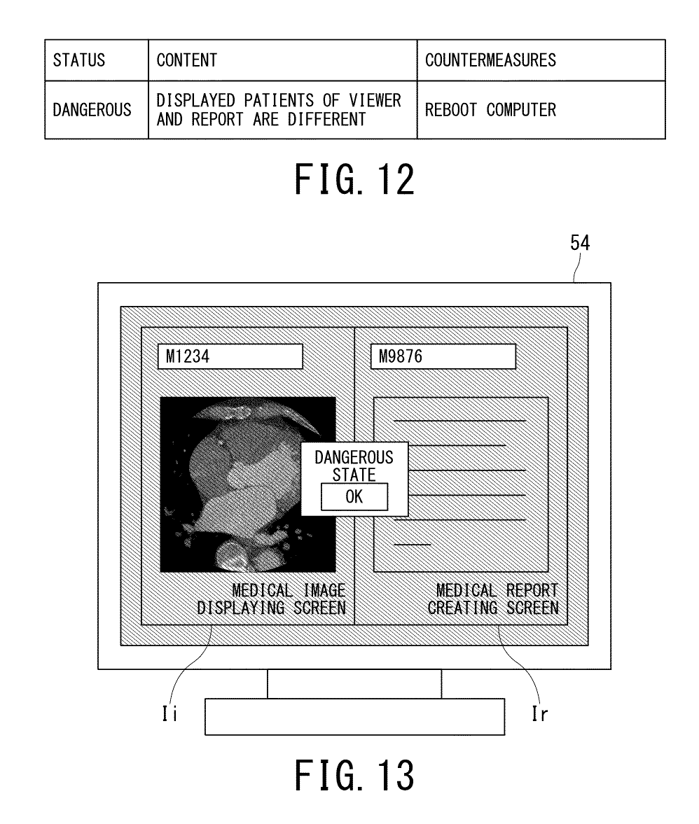

FIG. 12 is a diagram illustrating a first example of the dangerous state displayed on the displaying device 54.

The example illustrated in FIG. 12 shows the dangerous state displayed for the operator, in which the image displaying application (ID: viewer) and the report creating application (ID: report) display different patient IDs as illustrated in the lower part of FIG. 11. In the example illustrated in FIG. 12, countermeasures to be taken by the operator are displayed in addition to the dangerous state and contents of the dangerous state, on the screen (illustrated in FIG. 8) that is displayed on the displaying device 54 by the application screen display instructing unit 62. Accordingly, the operator can recognize the displayed dangerous state while viewing the screen that is displayed on the displaying device 54 by the application screen display instructing unit 62.

FIG. 13 is a diagram illustrating a second example of the dangerous state displayed on the displaying device 54.

The example illustrated in FIG. 13 shows the dangerous state displayed for the operator, in which the image displaying application (ID: viewer) and the report creating application (ID: report) display different patient IDs as illustrated in the lower part of FIG. 11. In the example illustrated in FIG. 13, a portion of the entire screen (illustrated in FIG. 8) that is displayed on the displaying device 54 by the application screen display instructing unit 62 is masked, the portion being other than the patient ID portion that is desired to be reported to the operator. Further, an “OK” button is placed on the screen. Then, the entire screen on the displaying device 54 is locked until the operator who operates the input device 53 pushes the “OK” button on the screen. If the operator pushes the “OK” button on the screen, the masking is cancelled, and the determination result display instructing unit 68 stands by for setting of a patient ID by the patient setting unit 61. Accordingly, the operator can recognize the displayed dangerous state while viewing the screen that is displayed on the displaying device 54 by the application screen display instructing unit 62.

According to the displaying methods illustrated in FIG. 12 and FIG. 13, the dangerous state, in which the identity of the displayed patient does not exist between a plurality of medical applications that are required to have the identity of the displayed patient, can be easily reported to the operator.

The record instructing unit 69 illustrated in FIG. 7 has a function of instructing, if the identity determining unit 67 determines that the client terminal 13 is in the dangerous state, the memory 52 and the like to record the dangerous state of the client terminal 13. A recording destination of the record instructing unit 69 is an event log or a document (a report and the like) being created in the corresponding state. Information recorded by the record instructing unit 69 contains at least occurrence of the dangerous state, occurrence time, and contents of the dangerous state. In addition, when the operator refers to a document being created in the dangerous state, the information recorded by the record instructing unit 69 may be presented to the operator in order to inform the operator of the fact that contents thereof may include a wrong diagnosis.

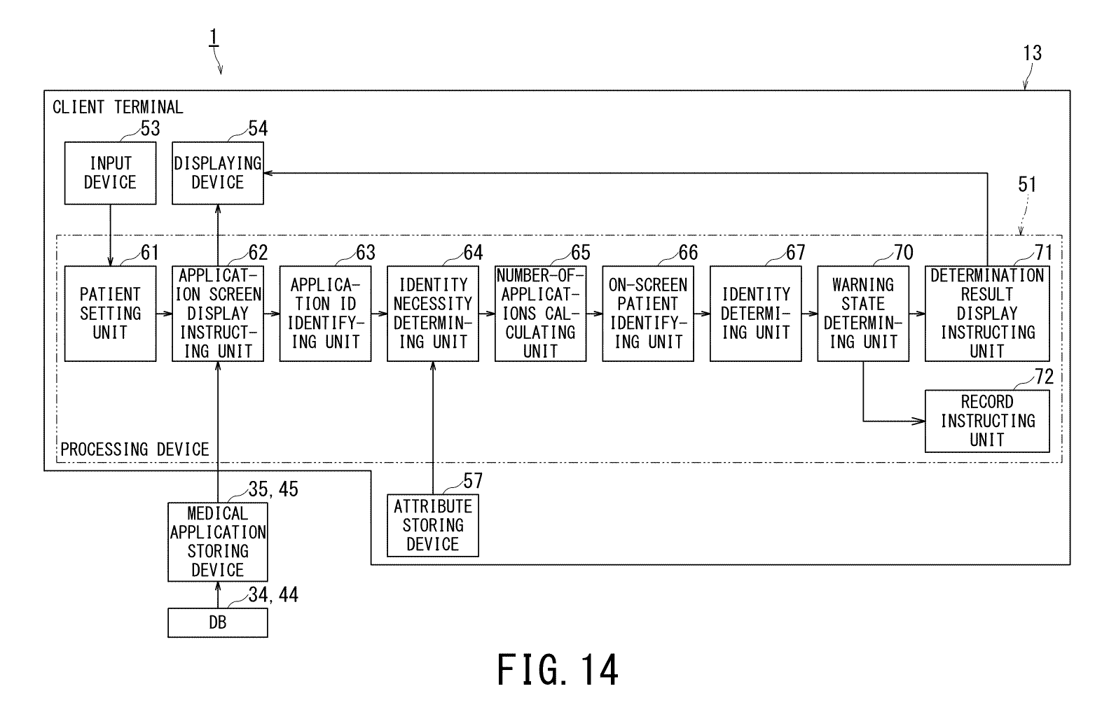

FIG. 14 is a block diagram illustrating a second function of the medical information managing system 1 according to the present embodiment.

When the processing device 51 illustrated in FIG. 2 executes a program, as illustrated in FIG. 14, the client terminal 13 functions as the patient setting unit 61, the application screen display instructing unit 62, the application ID identifying unit 63, the identity necessity determining unit 64, the number-of-applications calculating unit 65, the on-screen patient identifying unit 66, the identity determining unit 67, a warning state determining unit 70, a determination result display instructing unit 71, and a record instructing unit 72. Note that the entirety or a part of the components 61 to 67 and 70 to 72 of the client terminal 13 may be included in the client terminal 13 in the form of hardware. In addition, the entirety or a part of the components 61 to 67 and 70 to 72 may be included in any of the servers 12. In FIG. 14, the same components as those in FIG. 7 are denoted by the same reference signs, and description thereof is omitted.

The warning state determining unit 70 has a function of determining whether the normal state determined by the identity determining unit 67 is a normal state kept in the future or a warning state in which the client terminal 13 may come into the dangerous state in the future, according to future prospects of the current normal state on the basis of a process state of the client terminal 13. The warning state determining unit 70 determines whether the normal state determined by the identity determining unit 67 is the normal state kept in the future corresponding to a state where the process of the client terminal 13 is not locked or is the warning state where the process has no response. In the case of this warning state, the medical application locks the process.

The determination result display instructing unit 71 has a function of instructing, if the determination result by the identity determining unit 67 or the warning state determining unit 70 shows that the client terminal 13 is in the dangerous state or the warning state, the displaying device 54 to display this fact. If the dangerous state or the warning state is displayed on the displaying device 54, the determination result display instructing unit 71 stands by for setting of a patient ID by the patient setting unit 61.

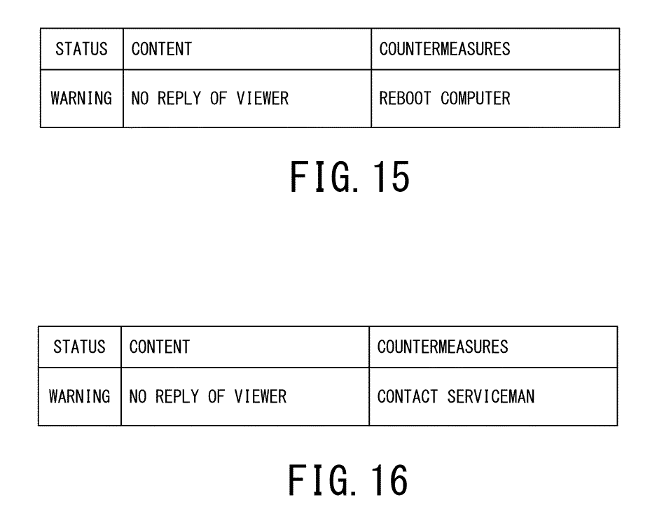

FIG. 15 is a diagram illustrating a first example of the warning state displayed on the displaying device 54.

The example illustrated in FIG. 15 shows the warning state displayed for the operator, in which the process has no response although the client terminal 13 is in the normal state where the image displaying application (ID: viewer) and the report creating application (ID: report) display the same patient ID as illustrated in the upper part of FIG. 11. In the example illustrated in FIG. 15, countermeasures to be taken by the operator are displayed in addition to the warning state and contents of the warning state, on the screen (illustrated in FIG. 8) that is displayed on the displaying device 54 by the application screen display instructing unit 62. Accordingly, the operator can recognize the displayed warning state while viewing the screen that is displayed on the displaying device 54 by the application screen display instructing unit 62.

Alternatively, the warning state determining unit 70 illustrated in FIG. 14 has a function of determining whether the normal state determined by the identity determining unit 67 is a normal state kept in the future or a warning state in which the client terminal 13 may come into the dangerous state in the future, according to future prospects of the current normal state on the basis of an echo response from the server 12. The warning state determining unit 70 determines whether the normal state determined by the identity determining unit 67 is the normal state kept in the future corresponding to a state where a response to an echo request to the server 12 is obtained or is the warning state corresponding to a state where no response to the echo request to the server 12 is obtained. In the case of this warning state, the server 12 has been down.

Alternatively, the warning state determining unit 70 has a function of determining, if a plurality of the client terminals 13 exist, whether the normal state determined by the identity determining unit 67 is a normal state kept in the future or a warning state in which the client terminal 13 may come into the dangerous state in the future, according to future prospects of the current normal state on the basis of an echo response from another client terminal. The warning state determining unit 70 determines whether the normal state determined by the identity determining unit 67 is the normal state kept in the future corresponding to a state where a response to an echo request to the another client terminal is obtained or is the warning state corresponding to a state where no response to the echo request to the another client terminal is obtained. In the case of this warning state, the network N has been shut down.

FIG. 16 is a diagram illustrating a second example of the warning state displayed on the displaying device 54.

The example illustrated in FIG. 16 shows the warning state displayed for the operator, in which the network N is in an abnormal state although the client terminal 13 is in the normal state where the image displaying application (ID: viewer) and the report creating application (ID: report) display the same patient ID as illustrated in the upper part of FIG. 11. In the example illustrated in FIG. 16, countermeasures to be taken by the operator are displayed in addition to the warning state and contents of the warning state, on the screen (illustrated in FIG. 8) that is displayed on the displaying device 54 by the application screen display instructing unit 62. Accordingly, the operator can recognize the displayed warning state while viewing the screen that is displayed on the displaying device 54 by the application screen display instructing unit 62. Further, the display of the dangerous state illustrated in FIG. 13 can be applied to the display of the warning state.

The record instructing unit 72 illustrated in FIG. 14 has a function of recording the dangerous state or the warning state of the client terminal 13 if the identity determining unit 67 determines that the client terminal 13 is in the dangerous state or if the warning state determining unit 70 determines that the client terminal 13 is in the warning state. A recording destination of the record instructing unit 72 is an event log or a document (a report and the like) being created in the corresponding state. Information recorded by the record instructing unit 72 contains at least occurrence of the dangerous state or the warning state, occurrence time, and contents of the dangerous state or the warning state. In addition, when the operator refers to a document being created in the dangerous state or the warning state, the information recorded by the record instructing unit 72 may be presented to the operator in order to inform the operator of the fact that contents thereof may include a wrong diagnosis.

Note that the medical information managing system 1 according to the present embodiment is described on the assumption that each medical application cannot display a plurality of pieces of patient information at the same time, that is, one medical application can display patient information of only one person at the same time.

Alternatively, the present embodiment can be expanded so as to cover a medical application that can display a plurality of pieces of patient information at the same time. In this case, the plurality of pieces of patient information are identified within a screen of the one medical application, and the identity of the patient is determined using the plurality of pieces of identified patient information. That is, in the case where one medical application displays pieces of patient information of two different persons, the client terminal 13 comes into the dangerous state at the moment at which a screen of the one medical application is displayed.

In the medical information managing system 1 according to the present embodiment, even in the case where different patient IDs are displayed on a plurality of screens corresponding to respective medical applications that are required to have the identity of the patient therebetween, the dangerous state, the warning state, and their countermeasures can be reported to the operator, so efficiency of operator's work can be improved.

Further, in the medical information managing system 1 according to the present embodiment, even in the case where different patient IDs are displayed on a plurality of screens corresponding to respective medical applications that are required to have the identity of the patient therebetween, the dangerous state and the warning state can be reported to the operator, so a risk of patient mix-up by the operator can be reduced.

Note that the above-mentioned embodiment is based on the assumption that the medical data from each server 12 is displayed on the client terminal 13 by executing the medical application provided by each server 12. The medical application does not necessarily need to be provided by each server 12, and may be stored in the client terminal 13 itself. In this case, the medical application storing devices 35 and 45 and the medical image DBs 34 and 44 included in the respective servers 12 illustrated in FIG. 2 also exist in the client terminal 13. Then, the processing device 51 executes a medical application stored in the medical application storing device of the client terminal 13, to thereby display a screen and logic of the executed medical application and a medical image stored in the medical image DB 34, 44 or the medical image DB of the client terminal 13. Also in such an embodiment, the attribute storing device 57 manages an attribute of the medical application stored in the client terminal 13, whereby an effect similar to that of the above-mentioned embodiment can be obtained.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A medical information managing system comprising:
a display instructing unit configured to generate data of a screen that shows medical data concerning patient information and to instruct a display device to display the screen if the medical data concerning the patient information is acquired from a storing device and if a medical application for displaying the acquired medical data is executed; and
an identity determining unit configured to determine, if a plurality of the medical applications are executed, an identity of a plurality of pieces of patient information corresponding to the respective medical applications.

2. A medical information managing apparatus comprising:
a display instructing unit configured to generate data of a screen that shows medical data concerning patient information and to instruct an outside medical information displaying apparatus to display the screen if the medical data concerning the patient information is acquired from a storing device and if a medical application for displaying the acquired medical data is executed; and
an identity determining unit configured to determine, if a plurality of the medical applications are executed, an identity of a plurality of pieces of patient information corresponding to the respective medical applications.

3. A medical information displaying apparatus comprising:
a display instructing unit configured to generate data of a screen that shows medical data concerning patient information and to instruct a display device to display the screen if the medical data concerning the patient information is acquired from a storing device and if a medical application for displaying the acquired medical data is executed; and
an identity determining unit configured to determine, if a plurality of the medical applications are executed, an identity of a plurality of pieces of patient information corresponding to the respective medical applications.

4. The medical information displaying apparatus according to claim 3, further comprising:
a storing unit configured to store, as attribute data, information indicating whether each of the plurality of medical applications requires having the identity of the patient information between this medical application and another medical application; and
a necessity determining unit configured to determine whether or not a medical application corresponding to the generated screen require having the identity, on a basis of the attribute data, wherein
the identity determining unit is configured to determine whether or not a plurality of pieces of patient information corresponding to the respective medical applications that are required to have the identity are identical with each other, if determining that a number of the medical applications that are required to have the identity is more than one, and
the display instructing unit is configured to issue, if the identity determining unit determines that the plurality of pieces of patient information are not identical with each other, an instruction to display this fact.

5. The medical information displaying apparatus according to claim 3, further comprising:
a storing unit configured to store a displaying region in which patient information is displayed on each of a plurality of screens corresponding to the respective medical applications; and
an identifying unit configured to identify the displaying region on each of the plurality of screens, wherein
the identity determining unit is configured to determine whether or not a plurality of pieces of patient information corresponding to the respective identified displaying regions are identical with one another, and
the display instructing unit is configured to issue, if the identity determining unit determines that the plurality of pieces of patient information are not identical with each other, an instruction to display this fact.

6. The medical information displaying apparatus according to claim 3, further comprising
a monitoring unit configured to receive first patient information of medical data that the medical application is requested to display, and to receive second patient information on the screen from the medical application that is requested to display, wherein
the monitoring unit is configured to compare the first patient information with the second patient information, and
the identity determining unit is configured to determine whether or not a plurality of pieces of patient information on a plurality of screens corresponding to the respective medical applications, on a basis of a result of the comparing by the monitoring unit.

7. The medical information displaying apparatus according to claim 3, wherein
the identity determining unit is configured to determine whether or not a process has any response, if determining that the plurality of pieces of patient information are identical with each other, and
the display instructing unit is configured to issue, if the identity determining unit determines that the process has no response, an instruction to display this fact.

8. The medical information displaying apparatus according to claim 7, further comprising
a record instructing unit is configured to issue, if the identity determining unit determines that the process has no response, an instruction to record this fact.

9. The medical information displaying apparatus according to claim 3, wherein
the identity determining unit is configured to determine, if determining that the plurality of pieces of patient information are identical with each other, whether or not a response to an echo request to a medical information managing apparatus is obtained, and
the display instructing unit is configured to issue, if the identity determining unit determines that no response to the echo request is obtained, an instruction to display this fact.

10. The medical information displaying apparatus according to claim 9, further comprising
a record instructing unit configured to issue, if the identity determining unit determines that no response to the echo request is obtained, an instruction to record this fact.

11. The medical information displaying apparatus according to claim 3, further comprising a record instructing unit, wherein
the record instructing unit is configured to instruct, if the identity determining unit determines that the plurality of pieces of patient information are not identical with each other, the storing device to record this fact.

12. The medical information displaying apparatus according to claim 3, wherein
if the identity determining unit determines that a process has no response or that no response to an echo request to a medical information managing apparatus is obtained, a portion of the screen is masked for operation restriction, the portion being other than a portion of the patient information.

13. The medical information managing system according to claim 1, further comprising
a plurality of medical information displaying apparatuses including the respective display instructing units and the respective identity determining units, wherein
an identity determining unit of one of the medical information displaying apparatuses determines, if determining that the plurality of pieces of patient information are identical with each other, whether or not a response to an echo request to the other is obtained,
a display instructing unit of the one issues, if the identity determining unit determines that no response to the echo request is obtained, an instruction to display this fact.
